(19) United States
(12) Patent Application Publication
(10) Pub. No.: US 2003/0113005 A1
(43) Pub. Date: Jun. 19, 2003

(54) Image processing system

(76) Inventors: Amit Saxena, Bangalore (IN); Pinaki Ghosh, Bangalore (IN)

Correspondence Address: Patrick W. Rasche, Armstrong Teasdale LLP, Suite 2600, One Metropolitan Sq., St. Louis, MO, 63102, US

(21) Appl. No.: 10/317,873

(22) Filed: Dec. 12, 2002

(30) Foreign Application Priority Data
Dec. 14, 2001 (JP) 2001-380966

(51) Int. Cl. G06K 9/00

(52) U.S. Cl. 382/128; 382/254; 358/3.27

(57) ABSTRACT

The present invention aims at readily calculating a difference between the positions of a plurality of images. Noises are removed from a plurality of halftone images representing the same object. The plurality of halftone images having noises removed therefrom is binary-coded. The barycenters of the binary-coded images are specified. A difference between the positions of the plurality of halftone images in image frames is calculated based on a difference between the positions of the barycenters thereof in the image frames. The plurality of halftone images are synthesized with the difference between the positions of the halftone images in the image frames corrected.

### BACKGROUND OF THE INVENTION

The present invention relates to an image processing method and system, or more specifically, it relates to a method and system for processing a plurality of halftone images representing the same object.

Medical images are very helpful in evaluating a patient's condition. The medical images provide unique information depending on a type of system that produces the medical images. Therefore, medical images produced by a proper type of imaging system are employed according to the purpose of evaluation. In order to achieve evaluation more accurately on the basis of versatile information, a plurality of kinds of medical images produced by a plurality of types of imaging systems are utilized concurrently.

For example, an X-ray computed tomography (CT) system and a positron emission tomography (PET) system are used to image the same region of the same patient. An X-ray CT image expressing the structure of the encephalic parenchyma and a PET image expressing the active state of the brain are used to evaluate a lesion in terms of both the structure of the lesion and the function thereof. In this case, a synthetic image produced by synthesizing both the images is also utilized in order to readily grasp the structure of the lesion and function thereof at the same time.

Accordingly, as far as images produced by different systems are concerned, the position of an image contained in an image frame does not always coincide with the position of the other image contained in the other image frame. Before two images are synthesized, the two images must be aligned with each other. The alignment is achieved by detecting a difference between the positions of the two images and correcting the difference. This image manipulation is performed by an image processing feature of a computer. However, an algorithm for detecting a difference between the positions of two images is so complex as to impose a large load on the computer.

### SUMMARY OF THE INVENTION

It is therefore an object of the present invention to provide an image processing method and system for readily detecting a difference between the positions of a plurality of images.

(1) In order to solve the foregoing problems, according to one aspect of the present invention, there is provided an image processing method for: binary-coding a plurality of halftone images that represents the same object; specifying the barycenters of the binary-coded images; and calculating a difference between the positions of the plurality of halftone images in image frames on the basis of a difference between the positions of the barycenters thereof in the image frames.

(2) In order to solve the aforesaid problems, according to another aspect of the present invention, there is provided an image processing system consisting mainly of: a binary-coding means for binary-coding a plurality of halftone images that represents the same object; a barycenter specifying means for specifying the barycenters of the binary-coded images; and a difference calculating means for calculating a difference between the positions of the plurality of halftone images in image frames on the basis of a difference between the positions of the barycenters thereof in the image frames.

According to the aspects (1) and (2) of the present invention, a plurality of halftone images representing the same object are binary-coded. The barycenters of the binary-coded images are specified. A difference between the positions of the plurality of halftone images in image frames is calculated based on a difference between the positions of the barycenters thereof in the image frames. Consequently, the difference between the positions of the plurality of images can be calculated readily.

(3) In order to solve the aforesaid problems, according to another aspect of the present invention, there is provided an image processing method for: removing noises from a plurality of halftone images representing the same object; binary-coding the plurality of halftone images having noises removed therefrom; specifying the barycenters of the binary-coded images; and calculating a difference between the positions of the plurality of halftone images in image frames on the basis of a difference between the positions of the barycenters thereof in the image frames.

(4) In order to solve the aforesaid problems, according to another aspect of the present invention, there is provided an image processing system consisting mainly of: a noise removing means for removing noises from a plurality of halftone images representing the same object; a binary-coding means for binary-coding the plurality of halftone images that has noises removed therefrom; a barycenter specifying means for specifying the barycenters of the two binary-coded images; and a difference calculating means for calculating a difference between the positions of the plurality of halftone images in image frames on the basis of a difference between the positions of the barycenters thereof in the image frames.

According to the aspects (3) and (4) of the present invention, noises are removed from a plurality of halftone images representing the same object. The plurality of halftone images having noises removed therefrom is binary-coded. The barycenters of the binary-coded images are specified. A difference between the positions of the plurality of halftone images in image frames is calculated based on a difference between the positions of the barycenters thereof in the image frames. Consequently, the difference between the positions of the plurality of images can be calculated readily while being unaffected by noises.

(5) In order to solve the aforesaid problems, according to another aspect of the present invention, there is provided an image processing method for: binary-coding a plurality of halftone images representing the same object; specifying the barycenters of the binary-coded images; calculating a difference between the positions of the plurality of halftone images in image frames on the basis of a difference between the positions of the barycenters thereof in the image frames; and synthesizing the plurality of halftone images with the difference between the positions of the halftone images corrected.

(6) In order to solve the aforesaid problems, according to another aspect of the present invention, there is provided an image processing system consisting mainly of: a binary-coding means for binary-coding a plurality of halftone images representing the same object; a barycenter specifying means for specifying the barycenters of the binary-coded images; a difference calculating means for calculating a difference between the positions of the plurality of halftone images in image frames on the basis of a difference between the positions of the barycenters thereof in the image frames; and a synthesizing means for synthesizing the plurality of halftone images with the difference between the positions of the halftone images corrected.

According to the aspects (5) and (6) of the present invention, a plurality of halftone images representing the same object is binary-coded. The barycenters of the binary-coded images are specified. A difference between the positions of the plurality of halftone images in image frames is calculated based on a difference between the positions of the barycenters thereof in the image frames. The plurality of halftone images is synthesized with the difference between the positions of the halftone images corrected. Consequently, the difference between the positions of the plurality of images can be calculated readily, and a synthetic image with the difference in position corrected can be produced.

(7) In order to solve the aforesaid problems, according to another aspect of the present invention, there is provided an image processing method for: removing noises from a plurality of halftone images representing the same object; binary-coding the plurality of halftone images that has noises removed thereof; specifying the barycenters of the binary-coded images; calculating a difference between the positions of the plurality of halftone images in image frames on the basis of a difference between the positions of the barycenters thereof in the image frames; synthesizing the plurality of halftone images with the difference between the positions of the halftone images corrected.

(8) In order to solve the aforesaid problems, according to another aspect of the present invention, there is provided an image processing system consisting mainly of: a noise removing means for removing noises from a plurality of halftone images representing the same object; a binary-coding means for binary-coding the plurality of halftone images that has noises removed therefrom; a barycenter specifying means for specifying the barycenters of the binary-coded images; a difference calculating means for calculating a difference between the positions of the plurality of halftone images in image frames on the basis of a difference between the positions of the barycenters thereof in the image frames; and a synthesizing means for synthesizing the plurality of halftone images with the difference between the positions of the halftone images corrected.

According to the aspects (7) and (8) of the present invention, noises are removed from a plurality of halftone images representing the same object. The plurality of halftone images having noises removed therefrom is binary-coded. The barycenters of the binary-coded images are specified. A difference between the positions of the plurality of halftone images in image frames is calculated based on a difference between the positions of the barycenters thereof in the image frames. The plurality of halftone images is synthesized with the difference between the positions of the halftone images corrected. Consequently, the difference between the positions of the plurality of images can be calculated readily while being unaffected by the noises. Moreover, a synthetic image with the difference in position corrected can be produced.

Preferably, the plurality of halftone images is two kinds of medical images. This contributes to effective pathological diagnosis.

Preferably, one of the two kinds of medical images is a tissular image, and the other is a functional image. This helps diagnose a lesion from both morphological and functional viewpoints.

According to the present invention, an image processing method and system capable of readily calculating a difference between the positions of a plurality of images can be realized.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing a system that is an example of an embodiment of the present invention.

FIG. 2 is a flowchart describing the operation of the system that is an example of the embodiment of the present invention.

FIG. 3 includes conceptual diagrams showing image frames.

FIG. 4 includes conceptual diagrams showing image frames.

FIG. 5 includes conceptual diagrams showing image frames.

FIG. 6 is a graph indicating the coordinates of the barycenters of images.

FIG. 7 is a conceptual diagram showing an image frame.

### DETAILED DESCRIPTION OF THE INVENTION

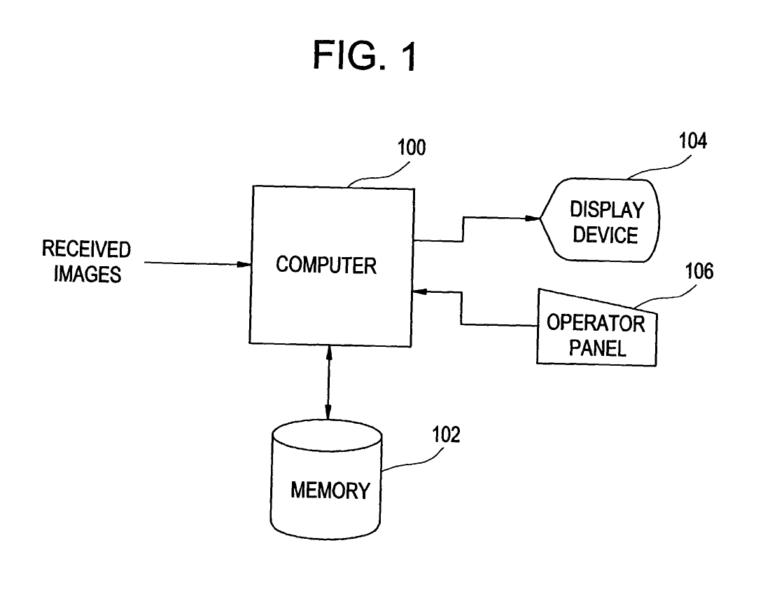

Referring to the drawings, an embodiment of the present invention will be described below. FIG. 1 is a block diagram showing an image processing system. The system is an example of the embodiment of the present invention. The configuration of the illustrated system refers to an example of the embodiment of a system in which the present invention is implemented. The operation of the illustrated system refers to an example of the embodiment of a method in which the present invention is implemented.

As shown in FIG. 1, the image processing system includes a computer 100. Images to be processed are transmitted to the computer 100. The computer 100 has a memory 102. Received images are stored in the memory 102. Moreover, various kinds of data and various programs that are used by the computer 100 are stored in the memory 102. When the computer 100 runs the programs stored in the memory 102, various kinds of data processing are performed in order to process images.

The computer 100 includes a display device 104 and an operator panel 106. The display device 104 displays images sent from the computer 100 or presents other information. The operator panel 106 is manipulated by a user and used to enter various instructions or information that is duly transmitted to the computer 100. The user uses the display device 104 and operator panel 106 to operate the system interactively.

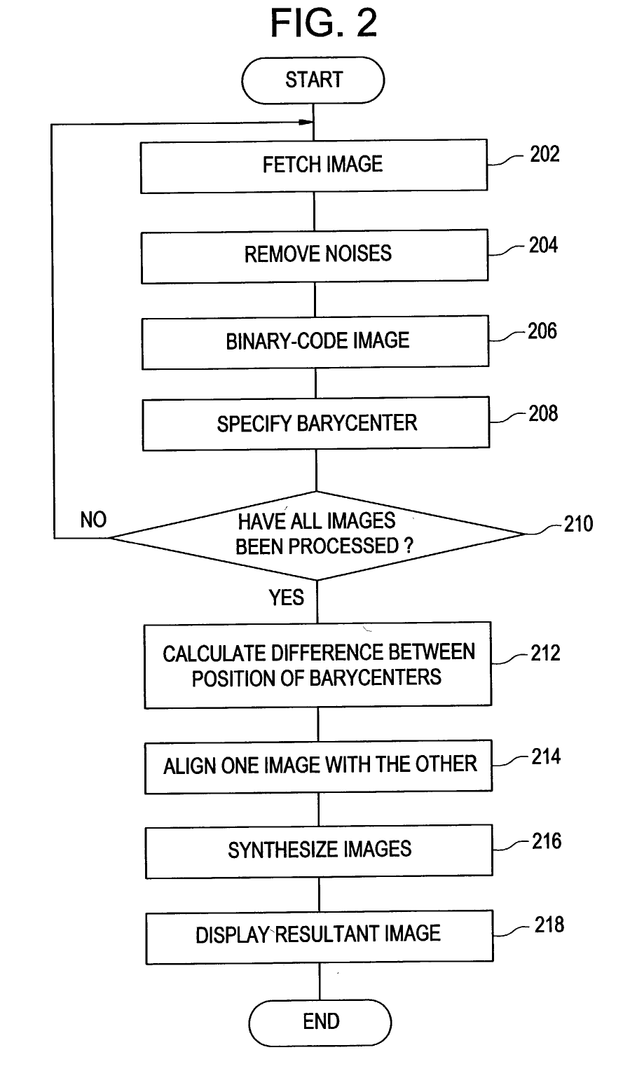

The operation of the present system will be described below. FIG. 2 is a flowchart describing the operation of the present system. The operation is executed when the computer 100 runs the programs stored in the memory 102.

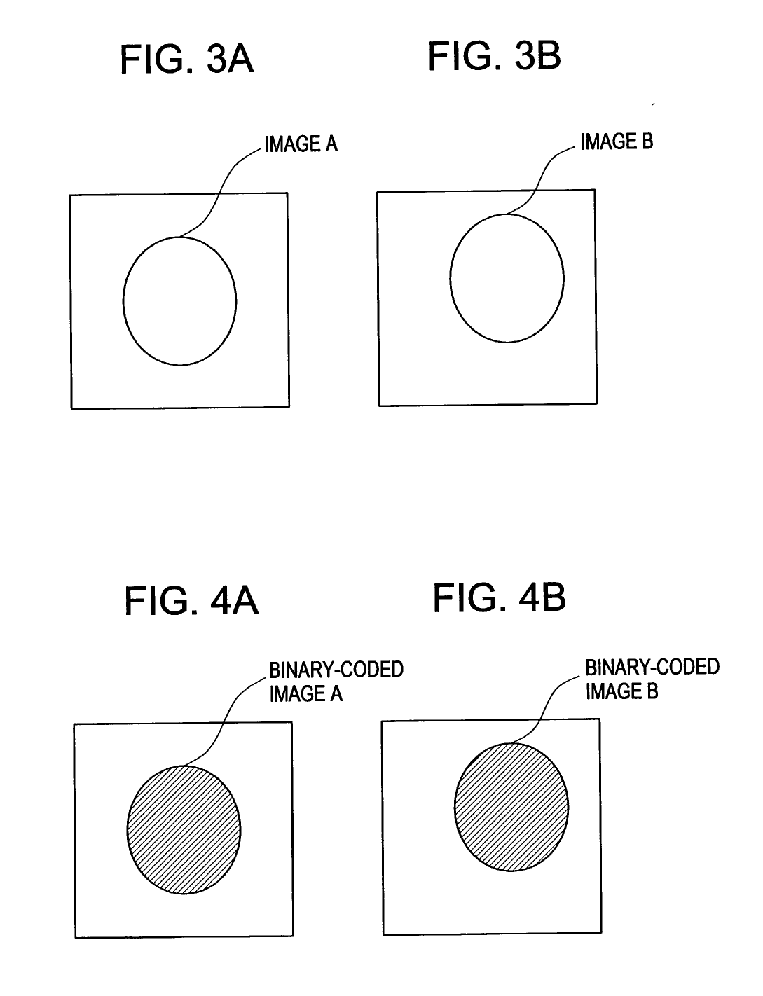

As described in the drawing, at step 202, an image interrupt is issued. Consequently, an image frame containing an image A like the one shown in, for example, FIG. 3(a) is stored in the memory 102. The image A is, for example, a tomographic image of the head produced by an X-ray CT system. The image A is a halftone image expressing the structure of the encephalic parenchyma.

Thereafter, at step 204, noises are removed. Noise removal is achieved by filtering the entire image frame, which contains the image A, using a filter such as a low-pass filter. The noise removal is performed when it is needed. If the number of noises is small, the noise removal maybe omitted. The computer 100 that performs the noise removal at step 204 is an example of a noise removing means, which is included in the present invention, employed in the embodiment.

At step 206, the image is binary-coded. Binary-coding is processing to be performed on all pixels constituting the image frame that contains the image A. Pixel values equal to or larger than a predetermined threshold are converted into 1s, and pixel values falling below the threshold are converted into 0s. This results in an image frame shown in FIG. 4(a). In the image frame, all the pixels constituting a binary-coded image a have the values thereof converted into 1s, and the other pixels have the values thereof converted into 0s. The computer 100 that performs binary-coding at step 206 is an example of a binary-coding means, which is included in the present invention, employed in the present embodiment.

Thereafter, at step 208, a barycenter is specified. Barycenter specification is processing of calculating the position of the barycenter of the binary-coded image a in the image frame. In general, when the moment of a binary-coded image is expressed as follows:

M(p, q)=Σi^{p}j^{q} (1)

(I, j)εs

the coordinates (m,n) of the barycenter of the binary-coded image are provided as follows:

m=M(1, 0)/M(0, 0) (2)

n=M(0, 1)/M(0, 0) (3)

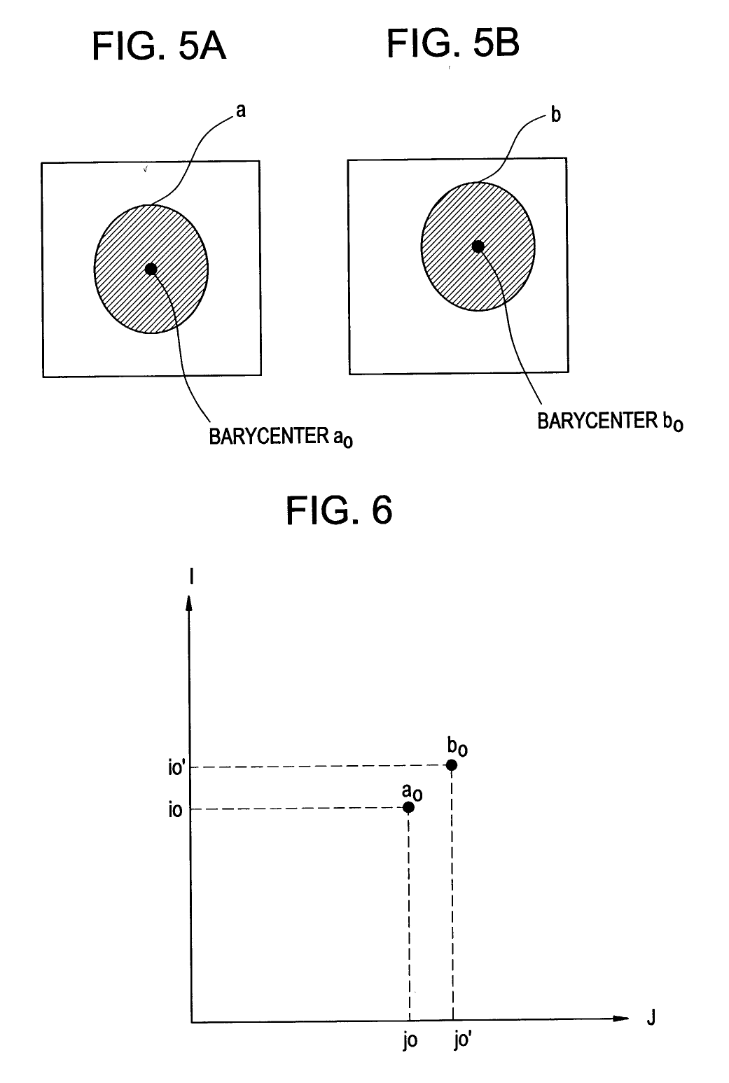

The above expressions are adapted to the image frame shown in FIG. 4a, whereby the coordinates of the barycenter a0 of the image a are calculated as shown in FIG. 5(a). The barycenter a0 serves as the barycenter of the binary-coded image a and as the barycenter of the halftone image A. Consequently, the coordinates of the barycenter of the image A are calculated. The computer 100 that specifies a barycenter at step 208 is an example of a barycenter specifying means, which is included in the present invention, employed in the present embodiment.

Thereafter, it is judged at step 210 whether the foregoing sequence has been completed relative to all images. If there is an image that should be processed, control is returned to step 202. The next image is then fetched.

Consequently, an image frame containing an image B shown in FIG. 3(b) is stored in the memory 102. The image B is a tomographic image of the same region in the head produced by, for example, the PET system. The image B is a halftone image expressing the encephalic function.

Thereafter, at step 204, noises are removed. Noise removal is achieved by filtering the entire image frame, which contains the image B, using an appropriate filter such as a low-pass filter. The noise removal is performed when it is needed. If the number of noises is small, the noise removal may be omitted.

At step 206, binary-coding is performed. The binary-coding is processing to be performed on all pixels constituting the image frame that contains the image B. Pixel values equal to or larger than a predetermined threshold are converted into 1s, and pixel values falling below the predetermined threshold are converted into 0s. This results in an image frame shown in FIG. 4(b). In the image frame, the pixels constituting the binary-coded image b have the values thereof all converted into 1s, the other pixels have the values thereof all converted into 0s. Owing to the noise removal performed at step 204, the binary-coded image is unaffected by noises.

At step 208, a barycenter is specified. Barycenter specification is processing of calculating the position of the barycenter of the binary-coded image b in the image frame. The position (coordinates) of the barycenter is calculated according to the aforesaid expressions (1) to (3). Consequently, as shown in FIG. 5(b), the coordinates of the barycenter b0 of the image B are calculated. The barycenter b0 serves as the barycenter of the binary-coded image b and as the barycenter of the halftone image B. It is thus considered that the coordinates of the barycenter of the image B are calculated.

The image A and image B are tomographic images representing the same region. The images have the barycenters thereof at the same positions therein. Since the image A and image B are produced by the different systems, the position of the image A in an image frame and the position of the image B in the other image frame do not always coincide with each other. Consequently, the coordinates of the barycenter of one of the images in the image frames do not always agree with the coordinates of the barycenter of the other image therein. FIG. 5(a) and FIG. 5(b) show such a relationship between the images.

When there is another image that should be processed, the sequence from step 202 to step 208 is repeated in order to specify the barycenter of the image. For example, assuming that there are two images which should be processed, a difference between the positions of the barycenters of the images in image frames is calculated at step 212 on the basis of the judgment made at step 210.

Assume that the coordinates representing the barycenters a0 and b0 of the binary-coded images a and b are calculated as (i0, j0) and (i0′, j0′) respectively. A difference between the positions of the barycenters is calculated as follows:

Δi=i₀−i₀′ (4)

Δj=j₀−j₀′ (5)

Herein, Δi denotes a difference in the direction of an axis I between the positions of the barycenters, while Δj denotes a difference in the direction of an axis J between them. The computer 100 that calculates a difference between the positions of barycenters at step 212 is an example of a difference calculating means, which is included in the present invention, employed in the present embodiment.

Thereafter, at step 214, the images are aligned with each other. Image alignment is processing of correcting the coordinates of the barycenters a0 and b0 so that the barycenters will be aligned with each other. In this example, the position of the barycenter b0 is matched with the position of the barycenter a0. The coordinates are corrected as expressed below.

i₀″=i₀′+Δi (6)

j₀″=j₀′+Δi (7)

Furthermore, along with the correction of the position of the barycenter, the coordinates (i′, j′) representing the locations of all the pixels that constitute the image B are corrected as expressed below. Owing to the coordinate correction, the coordinates representing the locations of all the pixels that constitute the image B are changed to the coordinates (i″, j″) that agree with the coordinates representing the locations of all the pixels that constitute the image A.

i″=i′+Δi (8)

j″=j′+Δj (9)

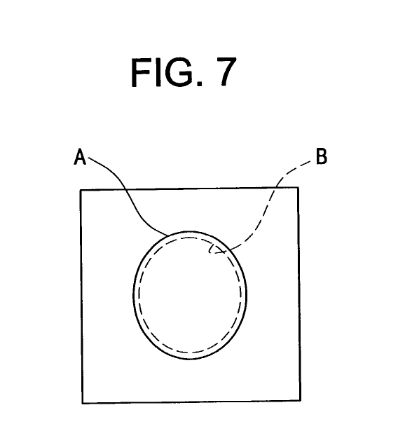

Thereafter, at step 216, the images are synthesized. Image synthesis is achieved by superposing the image B, which has undergone coordinate correction, on the image A. This results in a synthetic image shown in FIG. 7. Owing to the coordinate correction, the image B is perfectly superposed on the image A. The computer that performs image alignment and image synthesis at steps 214 and 216 is an example of a synthesizing means, which is included in the present invention, employed in the present embodiment.

The synthetic image is displayed on the display device 104 at step 218. The synthetic image is an image produced by superposing a functional image on a tissular image. The synthetic image helps efficiently evaluate a patient's condition.

Aligning the images, which are produced using the X-ray CT system and PET system respectively, with each other have been taken for instance. The present invention is not limited to the images produced using the X-ray CT system and PET system. Medical images produced using the other imaging systems can be aligned with each other in the same manner as mentioned above. Moreover, the present invention can be adapted not only to two-dimensional images but also to three-dimensional images. Moreover, needless to say, the present invention is not limited to medical images.

The present invention has been described based on the examples employed in the preferred embodiment. A person having an ordinary knowledge of the technical field to which the present invention belongs can make various modifications or replacements on the examples employed in the preferred embodiment without a departure from the technical scope of the present invention. Consequently, the technical scope of the present invention encompasses not only the aforesaid embodiment but also all embodiments belonging to claims.

Many widely different embodiments of the invention may be configured without departing from the spirit and the scope of the present invention. It should be understood that the present invention is not limited to the specific embodiments described in the specification, except as defined in the appended claims.

1. An image processing system comprising:
a binary-coding device for binary-coding a plurality of halftone images that represents the same object;
a barycenter specifying device for specifying the barycenters of the binary-coded images; and
a difference calculating device for calculating a difference between the positions of the plurality of halftone images in image frames on the basis of a difference between the positions of the barycenters thereof in the image frames.

2. An image processing system comprising:
a noise removing device for removing noises from the plurality of halftone images that represents the same object;
a binary-coding device for binary-coding the plurality of halftone images that has noises removed therefrom;
a barycenter specifying device for specifying the barycenters of the binary-coded images; and
a difference calculating device for calculating a difference between the positions of the plurality of halftone images in image frames on the basis of a difference between the positions of the barycenters thereof in the image frames.

3. The image processing system according to claim 1 or 2, wherein the plurality of halftone images is two kinds of medical images.

4. The image processing system according to claim 1 or 2, wherein one of the two kinds of medical images is a tissular image and the other is a functional image.

5. An image processing system comprising:
a binary-coding device for binary-coding a plurality of halftone images that represents the same object;
a barycenter specifying device for specifying the barycenters of the binary-coded images;
a difference calculating device for calculating a difference between the positions of the plurality of halftone images in image frames on the basis of a difference between the positions of the barycenters thereof in the image frames; and
a synthesizing device for synthesizing the plurality of halftone images with the difference between the positions of the halftone images corrected.

6. The image processing system according to claim 5, wherein the plurality of halftone images is two kinds of medical images.

7. The image processing system according to claim 5, wherein one of the two kinds of medical images is a tissular image and the other is a functional image.
